(19) United States
(12) Patent Application Publication
(10) Pub. No.: US 2012/0249447 A1
(43) Pub. Date: Oct. 4, 2012

(54) TOUCH PANEL AND TOUCH DISPLAY DEVICE USING THE SAME

(75) Inventor: Wei-Chen TSAI, New Taipei City (TW)

(73) Assignee: E INK HOLDING INC.

(21) Appl. No.: 13/353,987

(22) Filed: Jan. 19, 2012

(30) Foreign Application Priority Data
Mar. 29, 2011 (TW) 100110800

(51) Int. Cl. G06F 3/041

(52) U.S. Cl. 345/173

(57) ABSTRACT

A touch panel includes a first substrate, a color filter layer, several spacers, a first transparent electrode layer and a second transparent electrode layer. The color filter layer is located on the first substrate and the spacers are also located on the first substrate. The first transparent electrode layer covers the color filter layer and some of the spacers, in which the spacers covered by the first transparent electrode layer form several touch sensors. The second transparent electrode layer is disposed corresponding to the first transparent electrode layer. When the touch panel is touched to make the first transparent electrode layer sink such that the first transparent electrode contacts with the second transparent electrode layer, a voltage signal identifying the touched location is generated.

### RELATED APPLICATIONS

This application claims priority to Taiwan Application Serial Number 100110800, filed Mar. 29, 2011, which is herein incorporated by reference.

### BACKGROUND

1. Field of Invention

The present invention relates to an electrophoretic display (EPD). More particularly, the present invention relates to a touch electrophoretic display.

2. Description of Related Art

With the improvement of the flat panel display, the flat panel display devices having light and small features have become increasingly popular. The Liquid Crystal Display device (LCD), the Plasma Display device, the

Organic Light Emitting Diode display devices (OLED), the electrophoretic display device and display of other types are familiar. Compared with the flat panel displays of other kinds, the electrophoretic display device without light source is more power-saving. Therefore, the electrophoretic display device has been increasingly widely used in the electronic paper or other portable electronic devices.

In order to make the controlling steps more convenient, more and more portable electronic devices employ the touch-sensitive devices, and the touch electrophoretic display device having a touch panel is thus developed. In general, the touch electrophoretic display device consists of two parts, one part is the electrophoretic display panel, and the other part is the touch panel, the resistive touch panel for example.

The resistive touch panel is mainly composed of the transparent electrode film and the transparent electrode glass substrate, and the gap exists between the transparent electrode film and the transparent electrode glass substrate. Specific voltage is imposed across the electrode film and the glass substrate. By touching the transparent electrode film with the fingers or a pen, the transparent electrode film sinks toward and contacts with the transparent electrode glass substrate, and a voltage variation presenting the touched position occurs. The instructions and the following actions in accordance with the touched position are thus executed.

However, in such touch electrophoretic display device, the additional touch panel except the electrophoretic display panels is required to sense the touching of the users, that is, two sets of panel devices are required, which increase the manufacturing cost and device size of the electrophoretic display devices.

### SUMMARY

According to one embodiment of the present invention, a touch panel is disclosed, in which the touch panel includes a first substrate, a color filter layer, a lot of spacers, a first transparent electrode layer, and a second transparent electrode layer. The color filter layer is disposed on the first substrate; the spacers are also disposed on the first substrate; the first transparent electrode layer covers the color filter layer and some of the spacers, in which the spacers covered by the first transparent electrode layer form a plurality of touch sensors; the second transparent electrode layer is disposed corresponding to the first transparent electrode layer, in which a voltage variation signal identifying a touched location is generated when the touch panel is touched to make the first transparent electrode layer sink to contact with the second transparent electrode layer.

According to still another embodiment of the present invention, a touch display device is disclosed, in which the touch display device includes the above-mentioned touch panel and a display device. The display device is disposed adjacent to the touch panel for displaying images.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is the block diagram of the touch display device according to one embodiment of the present invention;

FIG. 2A is the structure diagram of the touch display device according to one embodiment of the present invention; and

FIG. 2B is the structure diagram of the touch display device according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

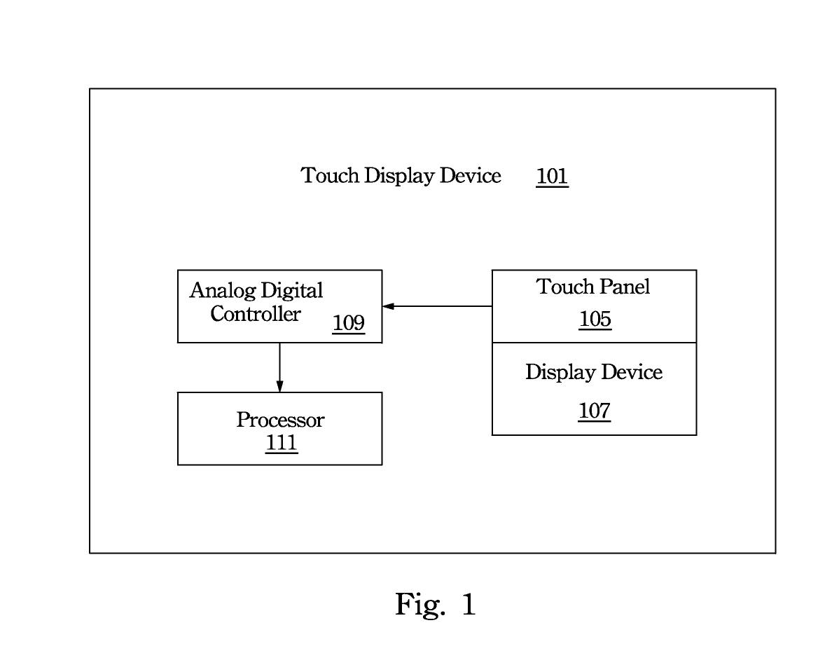

FIG. 1 is the block diagram of the touch display device according to one embodiment of the present invention. In the embodiment, the touch display device may be a touch electrophoresis display device 101. The touch electrophoresis display device 101 executes the actions in accordance with a user's touch, in which the touch electrophoresis display device 101 substantially includes the a touch panel 105, a display device 107, the analog digital controller 109, and the processor 111. The display device 107 is disposed adjacent to the touch panel 105 for displaying the images. When the touch panel 105 of the touch display device 101 is touched, a voltage variation signal identifying a touched location is generated. After that, the analog digital controller 109 receives the voltage variation signal and converts the voltage variation signal into a digital signal, and the processor 111 computes the touched location according to the digital signal.

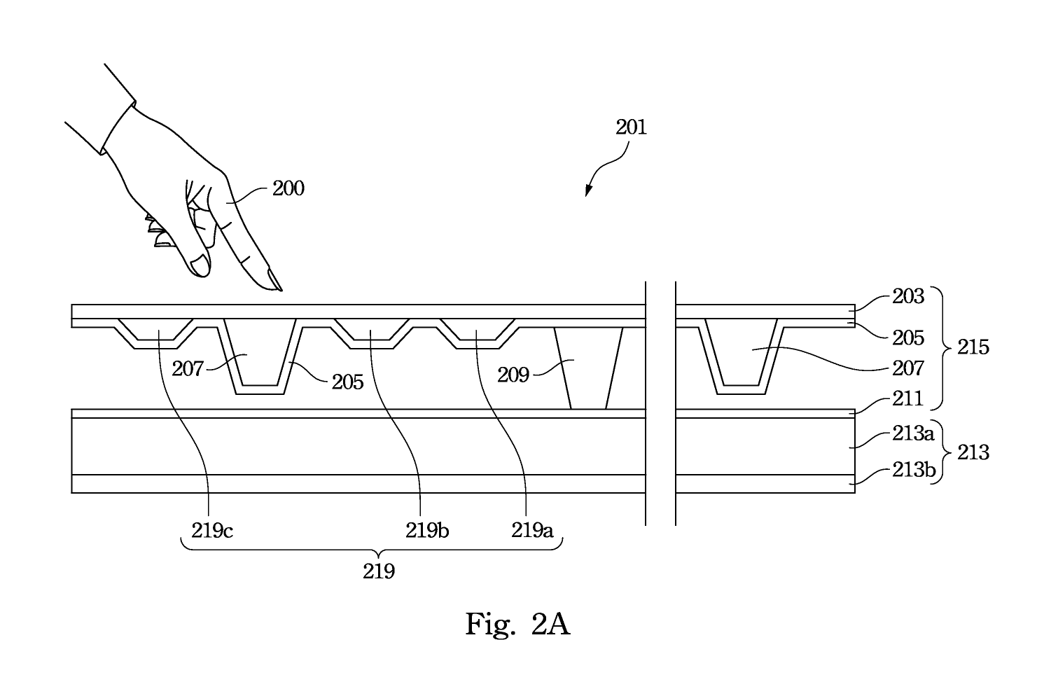

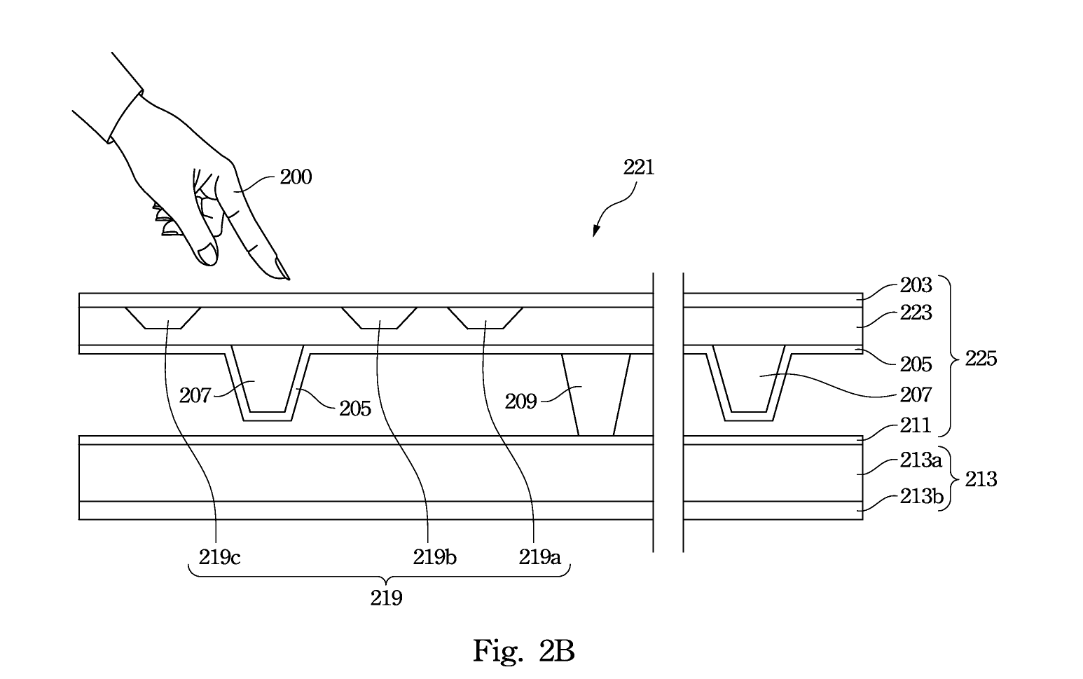

FIG. 2A is the structure diagram of the touch display device according to one embodiment of the present invention. The touch display device 201 executes the actions in accordance with the user's touch. For example, if the user's finger 200 or a pen presses the icon representing the social group website on the touch display device 201, the social group website application program is executed. Then the user can link the social group website to check his/her friend's state and other information therein.

The touch display device 201 includes a touch panel 215 and a display device 213. The touch panel 215 includes a first substrate 203, a color filter layer 219, several photo spacers 207/209, a first transparent electrode layer (Indium Tin oxide; ITO) 205, and a second transparent electrode layer 211.

The color filter layer 219 is disposed on the first substrate 203. In general, the color filter layer 219 is usually employed to process the light of a single color to produce the colorful images. The color filter layer 219 is mainly composed of the red color filter 219a, the green color filter 219b, and the blue color filter 219c. In more detail, the red, the green, and the blue (primary colors) organic materials are formed within each pixel on the glass substrate to produce the color filter (219a, 219b, 219c). Due to the high precision, better light resistance, and better heat endurance, the pigment dispersion method becomes the mainstream to produce the color filters of the current TFT.

The photo spacer 207/209 are disposed on the first substrate 203; the first transparent electrode layer 205 covers the color filter layer 219 and some of the photo spacer 207, in which the photo spacer 207 covered by the first transparent electrode layer 205 form the touch sensors. The photo spacer 209 is taken for separating the first transparent electrode layer 205 and the second transparent electrode layer 211, such that the two transparent electrode layers 205/211 do not contact each other and perform error action unconsciously. The second transparent electrode layer 211 is disposed corresponding to the first transparent electrode layer 205 and is disposed on a surface of the display device 213 toward the touch panel 215, in which a voltage variation signal identifying a touched location is generated when the touch panel 215 is touched to make the first transparent electrode layer 205 sink to contact with the second transparent electrode layer 211. Then, the analog digital controller 109 receives the voltage variation signal and converts the voltage variation signal into a digital signal, and the processor 111 computes the location to perform the touching function according to the digital signal, as illustrated in FIG. 1.

Through the color filter layer 219, the photo spacer 207, the first transparent electrode layer 205, and the second transparent electrode layer 211, the touched location is computed and the touching function is performed, and the additional touch panel is no longer required, which reduces the manufacture costs.

The display device 213, such as an electrophoresis display device, is disposed adjacent to the second transparent electrode layer 211 of the touch panel 215 for display the images, in which the display device 213 is closely contacted with the touch panel 215. The display device 213 substantially includes the transistor array substrate 213b and the electrophoresis display layer 213a. The transistor array substrate 213b has a lot of transistors disposed thereon (not shown), in which the transistor array substrate 213b can be a rigid substrate or a flexible substrate.

The electrophoresis display layer 213a is disposed on the transistor array substrate 213b and also disposed between the transistor array substrate 213b and the second transparent electrode layer 211, in which the electrophoresis display layer 213a can be a microcapsule type electrophoresis display layer controlled by the transistors on the transistor array substrate 213b to show the images. In more detail, the electrophoretic display layer 213a includes a lot of microcapsules, each microcapsule contains several first charged particles and several second charged particles.

The first charged particles and second charged particles have different colors and different electrical properties; that is, the first charged particles and the second charged particles respectively carry the positive charges and the negative charges. When the transistors of the transistor arrays substrate 213b vary the electric field, the first charged particles and the second charged particles are moved, so that the display device 213 can display various pictures.

FIG. 2B is the structure diagram of the touch display device according to another embodiment of the present invention. The touch display device 221 executes the actions in accordance with a user's touch, in which the touch display device 221 substantially includes a touch panel 225 and a display device 213. In this embodiment, the touch panel 225 and the display device 213 have almost the same structures as shown in FIG. 2A, except that an additional insulating layer 223 is contained, and the disposing of the first transparent electrode layer 205 in FIG. 2B is slightly different form that shown in FIG. 2A.

In this embodiment, the color filter layer 219 is disposed on the first substrate 203. The insulating layer 223 is disposed between the first substrate 203 and the first transparent electrode layer 205, in which the insulating layer 223 covers the color filter layer 219 while the photo spacers 207 and the first transparent electrode layer 203 are disposed on the insulating layer 223. The photo spacer 209 contacts with the first transparent electrode layer 205, and the photo spacer 207 wrapped by the first transparent electrode layer 205 forms the touch sensors. When the touch panel 225 is touched to make the first transparent electrode layer 205 sink to contact with the second transparent electrode layer 211, a voltage variation signal identifying a touched location is generated. As a result, the touched location/position of the touch panel 225 can be identified, and the touch function can be implemented without the extra touch panel.

The touch panel and the touch display device of the above embodiments utilize the transparent electrode layer and the gap material (photo spacers) already existing in the display device, in which the transparent electrode layer is attached to the bellowing of the gap material to realize the built-in resistive touch feature. In the meanwhile, the existing color filter layer process can be still used, so the outside touch panel is no longer required, which reduces the manufacturing costs and simplifies the making process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a first substrate;
a color filter layer disposed on the first substrate;
a plurality of spacers disposed on the first substrate;
a first transparent electrode layer covering the color filter layer and some of the spacers, wherein the spacers covered by the first transparent electrode layer form a plurality of touch sensors; and
a second transparent electrode layer disposed corresponding to the first transparent electrode layer, wherein a voltage variation signal identifying a touched location is generated when the touch panel is touched to make the first transparent electrode layer sink to contact with the second transparent electrode layer.

2. The touch panel as claimed in claim 1, further comprising:
an insulating layer disposed between the first substrate and the first transparent electrode layer, wherein the insulating layer covers the color filter layer while the spacers and the first transparent electrode layer are disposed on the insulating layer.

3. A touch display device, comprising:
a touch panel comprising:
a first substrate;
a color filter layer disposed on the first substrate;
a plurality of spacers disposed on the first substrate;
a first transparent electrode layer covering the color filter layer and some of the spacers, wherein the spacers covered by the first transparent electrode layer form a plurality of touch sensors; and
a second transparent electrode layer disposed corresponding to the first transparent electrode layer, wherein a voltage variation signal identifying a touched location is generated when the touch panel is touched to make the first transparent electrode layer sink to contact with the second transparent electrode layer; and
a display device, disposed adjacent to the second transparent electrode layer of the touch panel for displaying images.

4. The touch display device as claimed in claim 3, wherein the second transparent electrode layer is disposed on a surface of the display device toward the touch panel.

5. The touch display device as claimed in claim 3, wherein the display device is an electrophoresis display device.

6. The touch display device as claimed in claim 5, wherein the display device comprises:
a transistor array substrate having a plurality of transistors disposed thereon; and
an electrophoresis display layer disposed on the transistor array substrate and between the transistor array substrate and the second transparent electrode layer, wherein the electrophoresis display layer is controlled by the transistors to show images.

7. The touch display device as claimed in claim 6, wherein the first substrate and the transistor array substrate are rigid substrates or flexible substrates.

8. The touch display device as claimed in claim 6, wherein the electrophoresis display layer is a microcapsule type electrophoresis display layer.

9. The touch display device as claimed in claim 3, wherein the touch panel further comprises an insulating layer disposed between the first substrate and the first transparent electrode layer, and the insulating layer covers the color filter layer while the spacers and the first transparent electrode layer are disposed on the insulating layer.

10. The touch display device as claimed in claim 3, further comprising an analog digital controller for receiving the voltage variation signal and converting the voltage variation signal into a digital signal.

11. The touch display device as claimed in claim 10, further comprising a processor for computing the touched location according to the digital signal.
